(19) United States
(12) Patent Application Publication
(10) Pub. No.: US 2005/0204307 A1
(43) Pub. Date: Sep. 15, 2005

(54) METHOD, SYSTEM AND INTERFACE ENABLING A USER TO ACCESS THE COMPUTER RESOURCES OF A COMPUTER PROCESSING DEVICE IN AN ERGONOMIC AND INTUITIVE MANNER

(76) Inventor: Francois Nadal, St Mande (FR)

Correspondence Address: JEFFREY FURR, 253 N. MAIN STREET, JOHNSTOWN, OH, 43031, US

(21) Appl. No.: 10/908,870

(22) Filed: May 31, 2005

(30) Foreign Application Priority Data
Nov. 29, 2002 (WO) 2004/051455 A1

(51) Int. Cl. G06F 3/00

(52) U.S. Cl. 715/789; 715/747; 715/745; 715/778; 715/779

(57) ABSTRACT

The invention relates to a method which enables a user (1) to access in an ergonomic and intuitive manner computer resources (2), such as application software and/or data of a computer processing device (3) that includes a human-machine interface (4). The method is designed, in particular, to enable a user (1) to meet requirements involving the need for several computer resources (2). The inventive method comprises a step whereby the human-machine interface (4) is structured into elements such as: user environments (77a) corresponding to each user (1) activities; objects (77b) which are suited to the activity of the user (1) in the environment (77a) under consideration, and actions (77c) which are attached to the objects (77b).

### RELATED APPLICATION

This application claims the benefit of PCT Application WO 2004/051455, with a priority date of Nov. 29, 2002.

### BACKGROUND

1. Field of the Invention

This invention relates to a method which enables a user (1) to access the computer resources (2), such as application software and/or data, of a computer processing device (3) comprising a human-machine interface (4) in an ergonomic and intuitive manner.

Within the scope of this invention, a data processing device can be local or connected via computer links, in particular the internet, to distant servers.

Within the scope of this invention, it is understood that computer resources of a computer device shall mean in particular software applications and or data. Within the meaning of this invention it is understood that data shall mean files and/or directories or data associated to software applications.

2. Description of Prior Art
There exist operating systems that enable access to files and/or directories and/or applications through an explorer type interface or through a sole workstation. There exist applications, in particular management applications, that enable access to data. It follows from the previous article that there exist a wide disparity of means to access data. However, there is no system that enables access using the same interface to access data and files of the user, in such a manner to present the entire user data within the same graphic space.
There exist operating systems that enable access to files and/or directories and/or applications through an explorer type interface and/or via a sole workstation. It follows from the previous article that there is no possibility for the user to organise their information in a logical manner. However, there is no system that enables simultaneous access to files and/or directories and/or applications of the user in a logical and graphic manner.
There exist operating systems that enable to initiate a contextual action available in the system, from files and/or directories and/or applications using an explorer type interface; however there does not exist any system offering actions where the system automatically detects the requirements of the user.
Users today have access to many data processing devices (Home computer, lap top for the office, desktop computer, PDA, music players mpeg3 . . . ). Each of these presents the information of the user in a different manner and possesses different application resources. Thus, the user has at their disposal a great variety of methods in the organisation and access to their information.

And yet, the development of high data throughput rate and the nomadic distribution of computer terminals leads the user to search a solution enabling to unify access and organisation of said information.

Therefore the important factor today is not so much knowing where information and computer resources can be found, but rather how the user organises their environments and which actions the user requires. Users have at their disposition more and more methods for high speed access, the important factor is not knowing where the information and computer resources are, but rather how they wish to find them and see them organised, independently from the operating system used.

### SUMMARY OF THE INVENTION

The invention relates to a method which enables a user (1) to access in an ergonomic and intuitive manner computer resources (2), such as application software and/or data of a computer processing device (3) that includes a human-machine interface (4).

The method is designed, in particular, to enable a user (1) to meet requirements involving the need for several computer resources (2).

The inventive method comprises a step whereby the human-machine interface (4) is structured into elements such as:
User environments (77a) corresponding to each user (1) activities,
Objects (77b) which are suited to the activity of the user (1) in the environment (77a) under consideration,
Actions (77c) which are attached to the objects (77b).

### BRIEF DESCRIPTION OF THE DRAWINGS

Other characteristics and advantages of the invention will appear in reading the description of variations in design of the invention that are given as an example (Only as an indication, but which are by no means exhaustive), and

FIG. 1 that represents the human-machine interface 4.

FIG. 2 that represents the first operating level of explorer 72.

FIG. 3 that represents the second level of operation of explorer 72.

FIG. 4, that represents the operation of the second window of navigation of explorer 73.

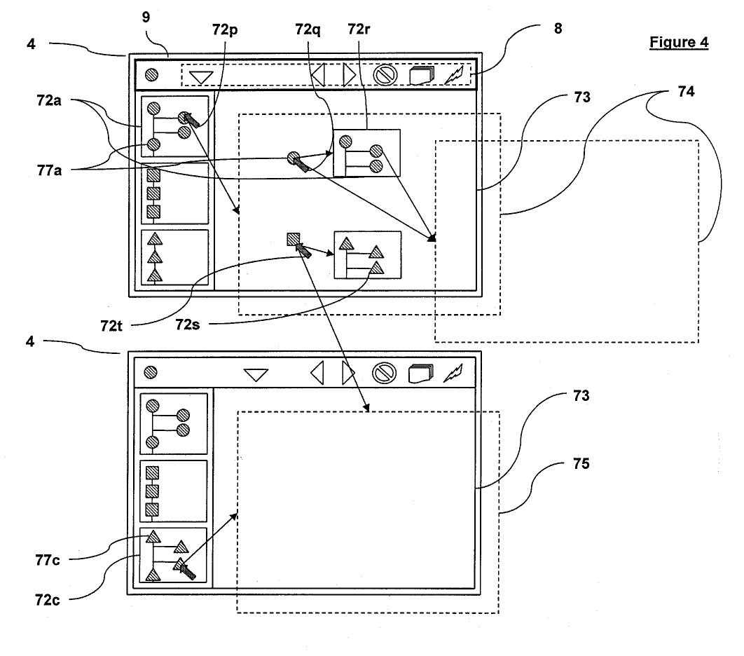

FIG. 5, that represents operation of the presentation of environment 74.

FIG. 6, that represents the operation of action assistant 75.

FIG. 7, that represents the system's automatic method of adaptation.

FIG. 8, that represents in a simplified manner a variation in design in case the computer processing device is connected via computer links.

Note: Under the description of figures:

The navigation tools 8 have also been referenced as 71b, 71c, 71d, 71e, 71f.

Command 9 has also been referenced as 71.

### DESCRIPTION OF THE PREFERRED EMBODIMENT

The invention concerns a method that enables the user to access in an ergonomic and intuitive manner, computer resources, in particular software applications and/or data of a computer processing device that includes a human-machine interface. The method is more specifically designed to enable a user to respond to requirements that need access to many computer resources. With the method, according to the invention, the necessary software applications may be unknown to the user.

The method includes the stage for structuring the human-machine interface in elements such as the following:
User environment corresponding to each user activity.
Objects that are appropriate to the activity of the user within the environment considered.
Actions attached to objects.

In this manner one achieves a common interface for the different user activities: finance and multimedia, grouping all necessary applications. The outcome from the combination of technical characteristics is that the method as per the invention enables to proceed from a “File, application data” approach normally used, to a “User environment” approach”.

According to the invention, the method preferably also includes another stage that enables associating software resources to environments, objects and actions in a logical manner. In this way the user, when opening the environment and/or the objects and/or the interface actions, has direct access to computer resources, in particular software applications and/or data.

Preferably, in the case of a variation in design according to the invention, one manually and/or automatically associates computer resources to thsaid environments, objects and actions.

Preferably, according to the invention, the human-machine interface is structured in elements (Environment, objects, and actions) as a function of the parameters provided by the user.

Following is a mention to various examples on the notion of environment, objects and actions.
As an example of environment, one can refer to “My Music” that presents the user with an ergonomic environment that enables them to access musical resources that are of interest to them.

The “My Music” environment can contain text and images, the objective being to explain the contents of the environment. “My Music” can also contain related environments, such as, for example, “MyJazz Music”, “My Classical Music”. These related environments enable responding more specifically to the preferences of the user.

The “My Classical Music” environment contains objects, “Mozart concert for flute no. 2 in d major”, and “Bach's stories on Hoffman”.

Actions are linked to objects, in the case of “Mozart concert for flute no. 2 in d major”, the actions “Listen”, “Send to a friend via internet”, “Transfer to my music box”, “Record on CDRom”, “Buy”, “Find similar music”, “Access resources regarding this music on the internet”, “Access resources regarding this music on my computer”, “Delete”, “Copy”, “File” “Move”, and “Properties”.
As an example of the environment concept, one also refers to “My administration” that presents the user with an ergonomic environment enabling them to access management resources that are of interest to them. This “My administration” contains elements, in particular:
Text and images whose objective is to explain the content of the environments.
Related environments, such as for example, “My Sales”, “My Expenses”. These enable to respond more specifically to the administrative requirements of the user.
Objects, such as for example within the “My sales” environment, the objects being “Clients” and “Salesperson”. The object “Client” may contain related objects such as for example “Large clients” and “Small clients”.
Actions linked to objects, in particular for “Clients” where the actions are “Create an invoice”, “See overdue client payments”, “Create a sales forecast”, “Call the client”, and “Send an email”.

The user graphically presents in their environments their software resources in the form of icons. They can also organise and personalise their work space. This organisation responds to the user's logic.

It is different from the presentation under the form of directories and files that are usually offered by operating systems. For example, previously, a user that administrated the commercial activity of a corporation created numerous files, mainly in text format, or spreadsheets from computer resources such as word processing software or spreadsheets. These files were accessible through a file explorer supplied by the operating system and was organised under directories.

Using the human-machine interface, according to the invention, the user can create an environment called “My commercial environment” in which they organise their own work logic and computer resources. In order to graphically present them within these environments, presentation of their computer resources (Appropriate application resources and data files to be worked on) is in the form of icons and in order to organise and personalise their work space, the user proceeds in the manner described hereunder. The user adds graphic elements into the environment “My commercial environment on Wednesday January 30th.” and, immediately following, creates a first block under the title of “My prospects to convince”, and finally, a block under the title of “My prospects that have requested a quote”. The user enters the files and/or information created previously using word processing software covering their prospects. In the second block, the user enters the quotes previously created using administration software. In this manner, the graphic separation of their environment enables access to their computer resources by organising it in a logical manner.

The user may, using existing environments, modify elements that form part of it. The user may, starting from an unused environment, create a new environment. For example, starting from the environment “My music” delete “Myjazz music” and rename “My classical music” to “My music of the 16th.Century”. Within “My music of the 16th.Century” they can integrate new objects such as, for example, an internet connection to a site dedicated to music of the 16th.century. These mechanisms are described later on by referring to table 10.

Below is a description of how it is possible to automatically associate computer resources to environments, objects and actions by referring to practical cases and examples.

In the case of an initial design, the user has access to a large number of environments by default for which logical associations have already been automatically designed.

In the case of a second design, the system saves the types of environments, objects and actions under memory. Each of these types possesses properties that are unique and each environment, object and action inherit the respective properties by types of environment, object and actions that are relevant. These properties define mainly the computer resources that the environment, objects and actions can be associated to. In this manner, the type of object disposes of properties that enable it to know the actions that are attachable and therefore the computer resources that can be associated to it. A user can manually modify the properties and the allocations.
The system saves computer resources available under memory. As an example, “Application A to listen to music”, “Application B to listen to music”, “Application A email administration”.
The system stores the types of action attached to available computer resources that are possible. As an example, the action “Listen to music” is attached to the computer resources “Application A to listen to music” and “Application B to listen to music”. The system includes a calculation mechanism enabling to automatically associate this type of action to the available resources.
The system stores objects linked to an environment. Similarly, the system stores actions linked to those objects. As an example, the “My music” type environment is attached to the object “Mozart concert for flute no. 2 in d major”. In effect, “Mozart concert for flute no. 2 in d major” is part of the field of concerts that represent a particular type of music. As an example, the object “Mozart concert for flute no. 2 in d major” is linked to the action “Listen to music”. Thus, an environment may have at its disposition acceptance rights of an object.

Preferably, according to the invention, the human-machine interface also includes navigation tools enabling the user to navigate between the elements by activating a sole command, the previous-next key.

Preferably, according to the invention, the human-machine interface includes data capture fields that enable the user, utilising the data captured, to launch a search in the data base, associated and/or associable to the computer device, in relation to the data captured.

Preferably, according to the invention, the search is made in the data bases in a logical relation to the selected element.

Preferably, according to the invention, the human-machine interface includes a command button, namely a unique key, that can be activated by the user in the following manner:—Means to transform downloaded files, namely html, elements and any or part of computer resources that are associated to it.
Means to download downloadable files from a distance.

In this manner one obtains a common interface for all the users' different activities: finance, multimedia, etc. One thus substitutes a <<Folder, application file>>approach to one of <<User Environment>>.

Human-Machine Interface

The invention refers to a system enabling a user to access computer resources in an ergonomic and intuitive manner, in particular application software and/or data on computer processing devices carrying a human-machine interface. The invention also refers to such a human-machine interface.

The system and/or human-machine interface are more specifically designed to enable the user to respond to requirements that need access to several computer resources. The human-machine interface, according to the invention, is structured in elements such as the following:
User environments corresponding to each user activity.
Objects appropriate to the activity of the user within the environment under consideration.
Actions linked to objects.

One thus designs a common interface for the different user activities: finance, multimedia, bringing together the necessary applications. The system and/or interface, according to the invention, enables to go from a <<Folder, file application>>approach to one of <<User environment>>.

Preferably, according to the invention, the human-machine interface includes also data processing methods that enable to associate, manually or automatically, and in a logical manner, the computer resources to the environments, objects and actions. In this manner the user, by opening the environment and/or objects and/or actions of the interface, has direct access to computer resources, mainly application software and/or appropriate data to respond to their requirements.

Preferably, according to the invention, the human-machine interface is structured in elements as a function of the parameters provided by the user.

Preferably, according to the invention, the human-machine interface includes, among others, navigation methods enabling the user to navigate between the elements by activating a unique command, i.e. a previous-next button.

Preferably, according to the invention, the human-machine interface includes a data capture field enabling the user to launch, from the captured data, a search in the data base, associated or associable to the computer devices in relation to the data captured.

Preferably, according to the invention, in the human-machine interface, the search is effected in the data base in logical relation to a selected element.

Preferably, according to the invention, the human-machine interface includes a command, i.e. a unique button, that can be activated by the user as follows:
Methods to transform into downloadable files, mainly html, the elements and any other portion of computer resources that are associated to it.
Methods to download the downloadable files from a distance.

One thus obtains a common interface for the different activities of the user: finance, multimedia, etc. . . . One thus substitutes a “Folder, application file” approach into one of “User environment”.

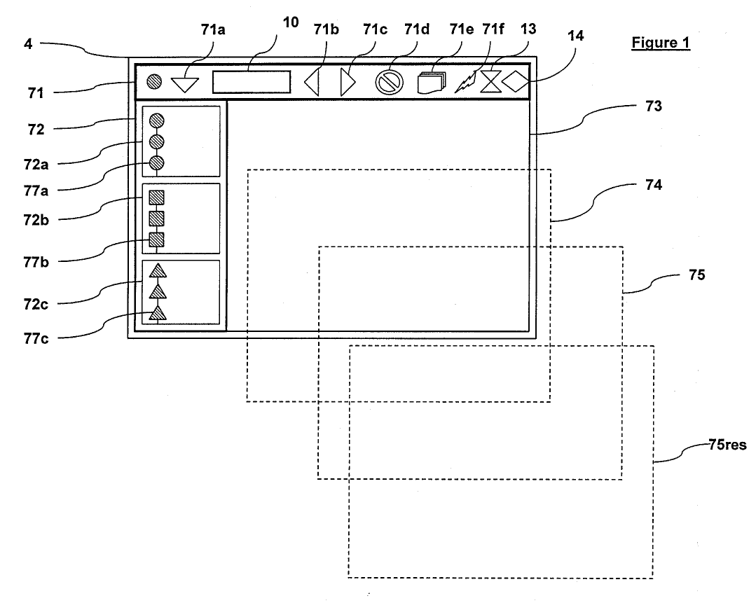

1. Following is a description regarding FIG. 1, the human-machine interface 4, which contains the following parts:
First general navigation bar 71.
Explorer 72.
Second window of navigation 73.

The first navigation bar 71 contains buttons that enable to navigate the human-machine interface 4 and in particular to select from 71A one of the second windows of navigation 73 among those that have been opened, go to the second window of navigation 73, 71b, go to the following second navigation window 73, 71c, close the second navigation window 73 en route to 71d, post 71e of explorer 72, personalise 71f human-machine interface 4, search 10 of information i.e. in logical liaison with the environment being used.

Explorer 72 is composed mainly of the following:
A first environment explorer 72a structure in the shape of a tree that contains environments 77a user adapted to the activity of user 1, namely a professional environment and a personal one.
A second explorer of objects 72b, structured in the form of a tree that contains objects 77b appropriate to the activity of user 1, namely for the professional environment objects that are: client, supplier, bank employee.
A third explorer of actions 72c structured in the form of a tree, that contains actions 77c attached to objects, mainly in order that the object client actions are to create an invoice, see overdue payment clients, create a prospective sale.

The second navigation 73 window contains namely, and/or:
The environment 74 presentations.
The assistants for actions 75.

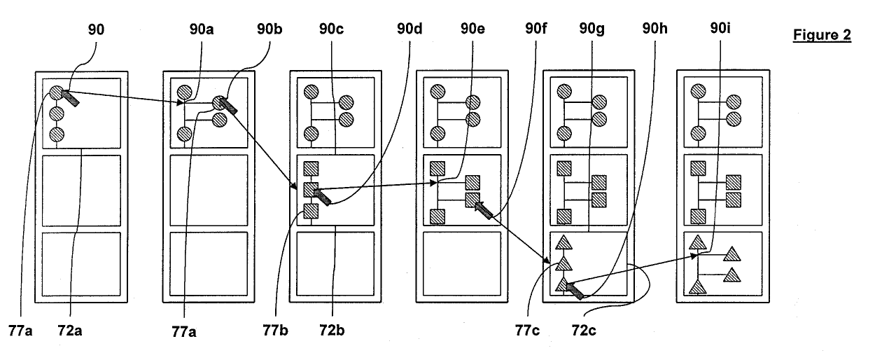

2. Following is a description, by referring to FIG. 2, of the first level of operation of explorer 72.

User 1.
By checking 90 on a knot of the tree contained in the first environment explorer 72a, scrolls 90a to the related environment 77a offspring.
By pointing 90b on one of the environment 77a, posts 90c in the second explorer objects 72b of the tree of objects 77b.
By pointing 90d on one of the 77b objects, moves 90e objects affiliates 77b.
By checking 90f on a 77b object, posts 90g on the third explorer, actions 72c of the tree of actions 77c.
By checking 90h on one of the 77c actions, scrolls 90i affiliate actions 77c.

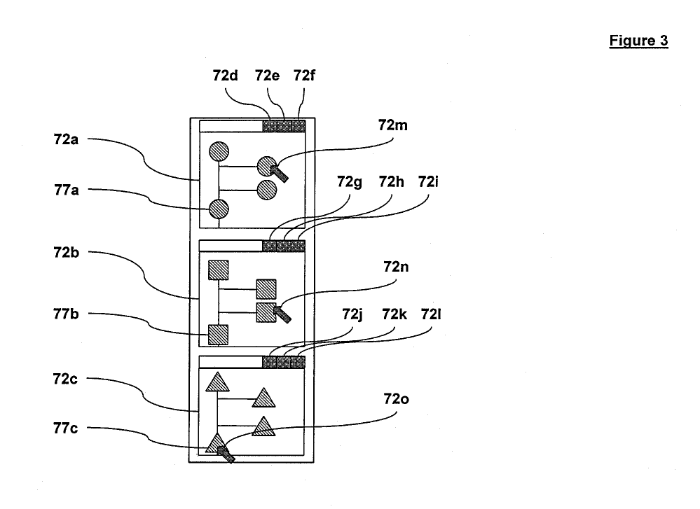

3. Now a description will follow on the second level of operation of explorer 72 by referring to FIG. 3,. The first environment explorer 72a contains in particualr the functions enabling the user 1 to adapt their environment 77a, i.e. by creating 72d, a new 72a environment, by deleting 72e from a 77a environment previously selected 72m, modifying the properties of 72f of a environment 77a previously selected by user 1.

The second explorer of objects 72b contains in particualr functions enabling user 1 to adapt 77b objects, i.e. by creating a new object 77b from 72g, deleting an object 77b from 77b previously selected 72n, modifying the properties of 72i of an object 77b previously selected 72n.

The third explorer of actions 72c contains mainly functions enabling user 1 to adapt those actions 77c, i.e. by creating a new action 72j, deleting an object 77b from 72k previously selected 72o, modifying the properties of 72l of an object 77b previously selected 72o.

It is understood that by 77a environment properties and/or objects 77b and/or actions 77c, these refer in particular to a wording, image, icon, identifier or a command to execute. For example, action 77c “Create an invoice” possesses the following properties: Wording=[create an invoice], image=[invoice image jpg], icon=invoice icon.gif], identifier=[234567]. Command to execute=[code line].

4. Now a description will follow regarding the functions of the second window of navigator 73.

The posting of an environment 74 presentation is effected by selecting 72p from the first environment explorer 72a, one of the 72a environments and/or selecting 72q from one of the 74 environment presentations, a presentation 72a.

The posting of one of the action assistants 75 is effected by selecting from the third explorer of actions 77c, one of the actions 77c and/or selecting from one of the environment 74 presentations, one of the 77c actions.

The posting of 72r from the first environment explorer is effected by selecting 72q from the presentations of environment 74, one of the 77a environments.

The posting of 72s of the third explorer of actions 72c is effected by selecting one of the 77c actions 72t from one of the environment presentations 74.

The presentation of environment 74 contains different elements, in particular environments 77a and/or objects 77b and/or actions 77c and/or image zones 74a and/or text zones 74b.

The user can create and/or delete and/or modify and/or move presentation elements of environment 74 onto the screen in such a manner that they can be personalised as a function of the thinking logic and/or manner in which consumer 1 organizes their activities. The elements contained in the environment 74 presentation are stored in memory.

The presentations of environment 74 in particular enable user 1 to organise in a personal manner access to files contained on the hard drive. For example, user 1 that administers in particular the commercial aspect of a firm, traditionally creates numerous files of a text type or spreadsheet using market software. These files are traditionally accessible from a file searcher supplied by the operating system and organised in the directories. From the human-machine interface 4, the user can create an environment 74 presentation whose title is “My commercial work” in order to place shortcuts to their files and/or illustrating images. The location of shortcuts to files and/or directories is effected thanks to a simple movement of the mouse to files and/or directories contained in the file explorer to the environment 74 presentation. The system and the method, according to the invention, enables user 1 to dispose of an understandable and personal view of their files and/or directory as opposed to the traditional view obtained by standard file explorers available in the market.

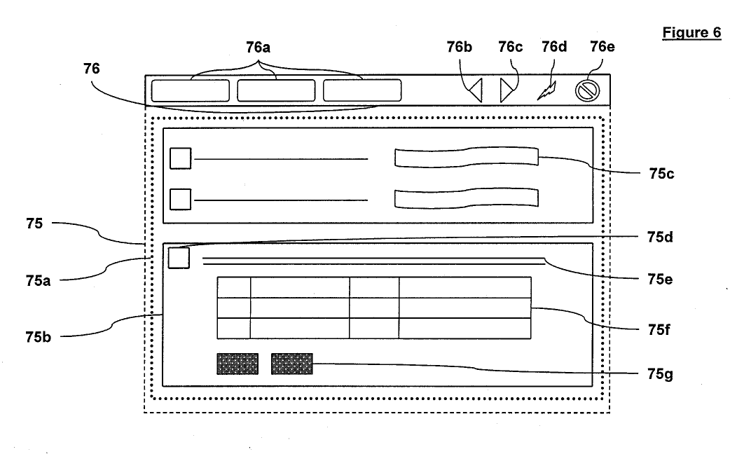

6. Now a description will follow regarding FIG. 6, the functions of action assistant 75.

The action assistant 75 contains mainly the following parts:
A second navigation bar 76.
Stages 75a.
Blocks 75b contained in each stage 75a.
Elements contained in each 75b block, mainly the 75c capture and/or visualisation fields, 75d images, text zones 75e, tables 75f for capture and/or visualisation, 75g buttons that activate functions.

The data captured and/or visualised in the 75 action assistant are stored in memory.

The second 76 navigation bar contains in particular text zones posting the title 76a of stages 75a, buttons enabling to navigate action assistant 75 and also to go to said stage 75, previously 76a, to 75a following 76c, personalise 76d action assistant 75, close 76e action assistant 75.

The human-machine interface 4 contains mainly functions enabling user 1 to adapt action assistants 75 as a function of their activity requirements.

User 1 can create and/or delete and/or modify and/or move stages 75a and/or blocks 75b and/or elements contained in blocks 75b.

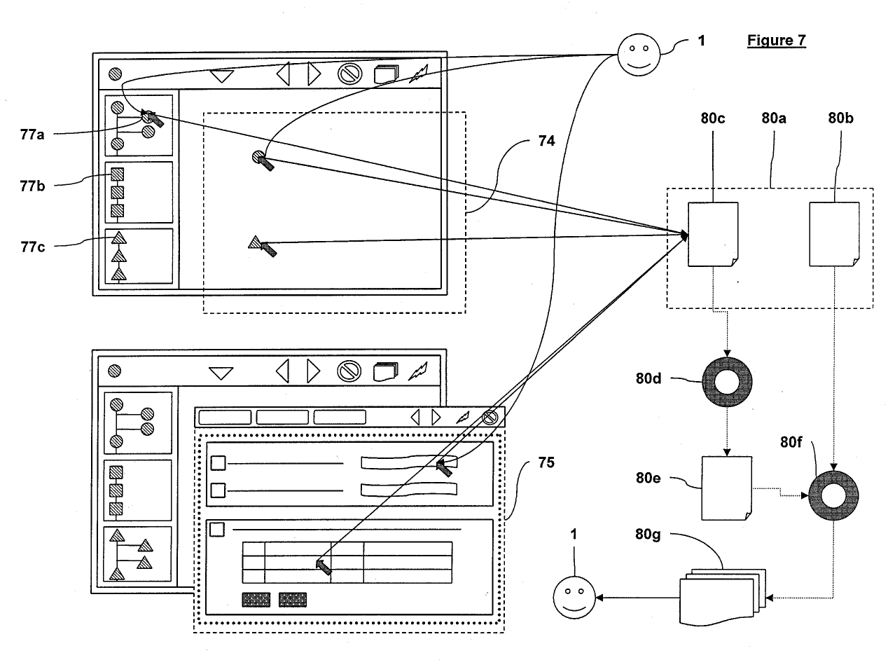

7. Using FIG. 7, following is a description on how the capacity of adaptability of the system is possible thanks to the following:
Structure of the human-machine interface 4 in environment 77a, objects 77b, actions 77c.
The structure of the personalisation of environment 74 presentations.
The personalisation of 75 action assistants.

The adaptation of the system is effected manually by user 1 and/or automatically.

Method for manual adaptation.

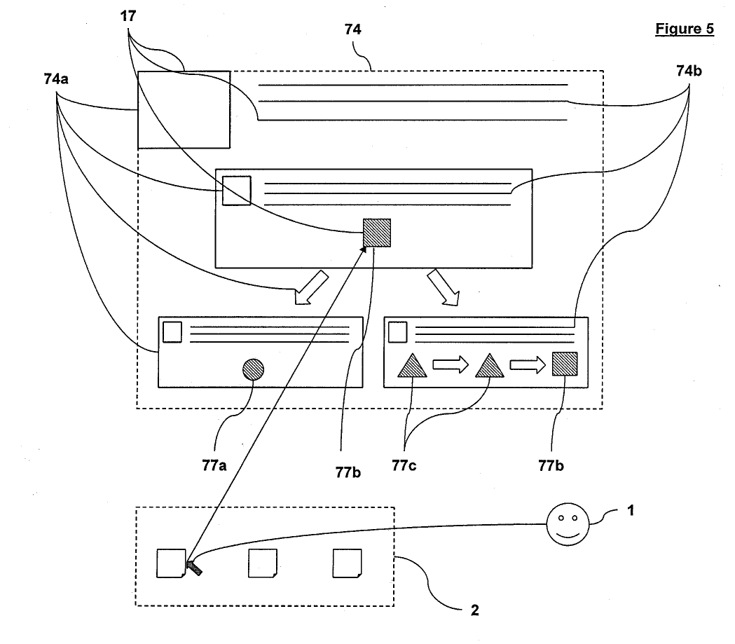

User 1 can manually personalise the system as follows: Personalising the elements contained in explorer 72 (FIG. 3) and/or by personalising the environment 74 presentations (FIG. 5) and/or personalising action assistants 75.

Method for automatic adaptation.

The system is capable, as a function of the use of human-machine interface 4 made by user 1, to adapt automatically. The automatic adaptation applies in particular to the structure of environment 77a and/or objects 77b and/or actions 77c on environment 74 presentations, on action assistants 75.

On the one part, the system stores in memory 80a the user models 80b that are appropriate to the different types of activities of user 1, in particular those that are personal, professional (Restaurant, building, commercial, accounting). On the other part, the system stores in the same memory 80a the history of actions 80c of user 1 carried out in the human-machine interface 4.

Then, from the historical data of actions 80c, a first method of calculation 80d is determined.
Usage indicators 80e of the environment structure 77a, objects 7b actions 77c, in particular the rate of clicking on environment 77a, objects 7b and actions 77c, and the frequency of clicks of these environments 77a, objects 77b and actions 77c.
Usage indicators 80e of the environment 74 presentation, in particular the rate of clicking on the elements contained in environment 74 presentation, the sequence of clicks between these elements, the time during which the environment 74 presentation is open, and the rate and the frequency of opening of environment 74 presentation.
Usage indicators 80e, action assistants 75, in particular the rate of clicking on elements contained in blocks 75b.

The system has available a second method of calculation 80f, starting on the one part from usage indicators 80e and another part of usage models 80b that are proposed to user 1:
An automatic modification 80g of the structure of environment 77a, objects 77b and actions 77c in a structure that is more adapted to the manner in which user 1 uses the system.
An automatic modification 80g of environment 74 presentations, in particualr the deletion and/or addition and/or modification of elements contained in environment 74 presentations, a reorganisation of the location of these elements in the environment 74 presentations.
An automatic modification 80g of action assistants 75, in particular create and/or delete and/or modify and/or move stages 75a and/or blocks 75b and/or elements contained in blocks 75b.

User 1 visualizes automatic 80g modifications proposed and can validate and/or reject whether these automatic 80g modifications affect the system.

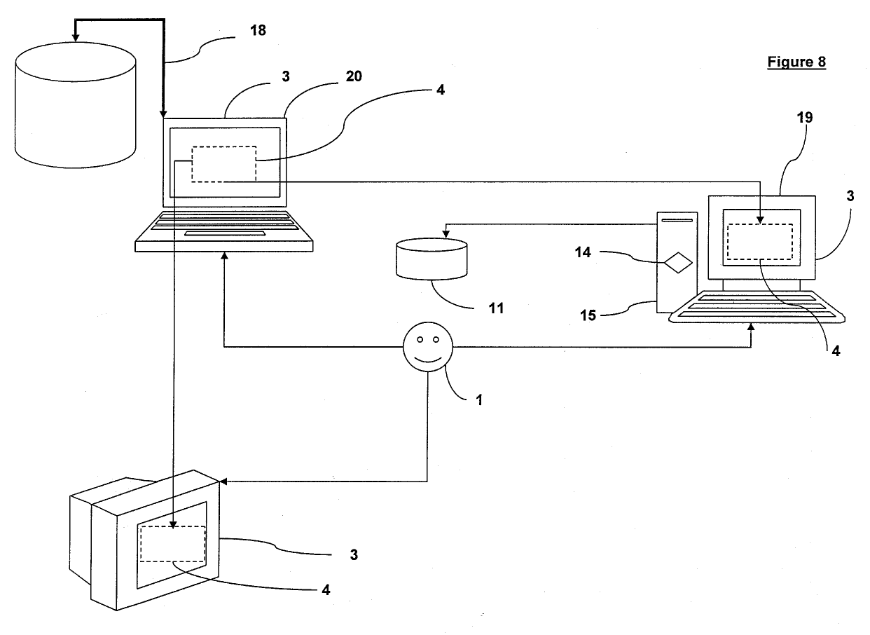

It has been said hereunder that within the meaning of this invention computer processing devices can be local or connected by software links, mainly via the internet, to distant servers. Now a description will follow by referring to FIG. 8 that presents in a simplified manner a variation in design in the case where devices are connected via computer links 18, of an example of design in the case where computer resources are located at a distance. The user creates their environments on computer A 19. These environments are linked to computer resources located at a distance or at their workstation A 19. This user has access to another computer B (Telephone, pda, notebook)20. With a click, the environments created on workstation A 19 are transferred to workstation B20. Automatically the entire computer resources and/or files created from application files linked to the environment are transferred to computer B 20. It is also possible for the user to manually select computer resources, namely files attached to the environment, that they wish to duplicate on workstation B 20. It is also possible to limit the size of files that are transferred.

By separating the environment (The logical presentation of the user) of the operating system, the user finds their work logic no matter which the terminal used. If the action attached to an object (Determined on workstation A 19) is not detected by the proper application, the system searches the substitute resources on workstation B 20 or on a remote site via the internet.

1. A method comprising enabling a user (1) to access in an ergonomically and intuitive manner computer resources (2), mainly application software and/or data, on a data processing device (3) that includes a human-machine interface (4), this method is more specifically designed to enable user (1) to respond to the requirements necessitating access to several computer resources (2), including the stage of structuring said human-machine interface (4) in elements such as: User environments 77a corresponding to each user activity (1), objects (77b) that are appropriate to the activities of said user (1) in the environment (77a) under consideration, and actions (77c) attached to said objects (77b) in such a manner that one can also achieve a common interface for all the different user activities (1): finance, multimedia, bringing together all necessary applications; which enables to go from a <<Folder, application file>>approach usually used to one of <<User (1) environment (77a)>>.

2. Method according to claim 1, in which the method includes among others, the stage of associating in a logical manner those computer resources (2) to those environments (5), objects (77b) and actions (77c); in order that the user (1), by opening said environments (77a) and/or objects (77b) and/or actions (77c) of the interface has direct access to said computer resources (2) in particular the application software and/or data in order to respond to their requirements.

3. Method according to claim 2 in which the said human-machine interface (4) is structured in elements as a function of the parameters provided by the said user (1).

4. Method according to claim 1 in which said human-machine interface (4) includes also methods of navigation (8) enabling the user (1) to navigate between the different elements by activating a unique command (9), in the form of a button <<Previous-next>>.

5. Method according to claim 1 in which the said human-machine interface (4) possesses a data capture field (10) enabling said user (1) to launch, from the captured data, a search in the data base (11) associated and/or associable to that data processing device (3) in relation to said captured data.

6. Method according to claim 4 in which said search is effected in the data base (11) in logical relation with a selected element.

7. Method according to claim 2 in which said human-machine interface (4) includes a command (9) in particular by using a unique button that can be activated by the said user (1) as follows: means of transformation (13) to transform said elements in downloadable files i.e. html, and all or part of computer resources (2) associated with it, means to download (14) in order to download from a distance said downloadable files in such a manner that one can obtain a common interface for the different activities of the user (1) in such a manner that one can substitute a <<Folder, application file>>approach to a <<User (1) environment (77a)>>approach.

8. System enabling a user (1) to access in ergonomic and intuitive manner computer resources (2) in particular application software and/or data on a data processing device (3) including a human-machine interface (4), with said system is more specifically designed to enable the said user (1) to respond to requirements necessitating access to various computer resources (2), said human-machine interface (4) is structured in elements such as: user environments (77a), corresponding to each activity of the user (1), objects (77b) appropriate to the activity of the user (1) in the environment (77a) under consideration and actions (77c) attached to said objects (77b), in such a manner that one can also design a common interface (4) for the different user activities (1): finance, multimedia, grouping all necessary applications in such a manner that the system, according to the invention, enables to go from a <<Folder, application file>>approach to one of <<User (1) environment (77a)>>.

9. System according to claim 8 in which said system includes also data processing methods (15) enabling to associate manually or automatically, in a logical manner, said computer resources (2) to said environments (5), objects (77b) and actions (77c) in such a manner that the user (1), by opening said environments (77a) and/or objects (77b) and/or actions (77c) of said interface (4), has direct access to said computer resources (2), in particular the application software and/or data appropriate to respond to their requirements.

10. System according to claim 9 in which said human-machine interface (4) is structured in elements as a function of the parameters provided by the user (1).

11. System according to claim 8 in which said human-machine interface (4) includes also navigation methods (8) enabling the user (1) to navigate between the different elements by activating a unique command (9), a <<previous-next>>button.

12. System according to claim 8 in which said human-machine interface (4) includes a data capture field (10) enabling the user (1) to launch, from said captured data, a search in the data base (11) associated and/or associable to the data processing device (3) in relation to said captured data.

13. System according to claim 11 in which said search being effected in the data bases (11) in logical relation to a selected element.

14. System according to claim 9 in which said human-machine interface (4) includes a command (9) in the form of a unique button activated by the user (1) as follows: means of transformation (13) to transform said elements into downloadable files (html) and all or part of computer resources (2) that are associated to it, methods to download (14) in order to download from a distance said downloadable files (16) in such a manner that one can obtain a common interface for the different user (1) activities: in such a manner that one can substitute a <<Folder, application file>>approach to one of <<User (1) environment (77a) of user (1).

15. Method according to claim 3 in which said human-machine interface (4) includes also methods of navigation (8) enabling the user (1) to navigate between the different elements by activating a unique command (9), in the form of a button <<Previous-next>>.

16. Method according to claim 4 in which the said human-machine interface (4) possesses a data capture field (10) enabling said user (1) to launch, from the captured data, a search in the data base (11) associated and/or associable to that data processing device (3) in relation to said captured data.

17. Method according to claim 6 in which said human-machine interface (4) includes a command (9) in particular by using a unique button that can be activated by the said user (1) as follows: means of transformation (13) to transform said elements in downloadable files i.e. html, and all or part of computer resources (2) associated with it, means to download (14) in order to download from a distance said downloadable files in such a manner that one can obtain a common interface for the different activities of the user (1) in such a manner that one can substitute a <<Folder, application file>>approach to a <<User (1) environment (77a)>>approach.

18. System according to claim 10 in which said human-machine interface (4) includes also navigation methods (8) enabling the user (1) to navigate between the different elements by activating a unique command (9), a <<previous-next>>button.

19. System according to claim 11 in which said human-machine interface (4) includes a data capture field (10) enabling the user (1) to launch, from said captured data, a search in the data base (11) associated and/or associable to the data processing device (3) in relation to said captured data.

20. System according to claim 13 in which said human-machine interface (4) includes a command (9) in the form of a unique button activated by the user (1) as follows: means of transformation (13) to transform said elements into downloadable files (html) and all or part of computer resources (2) that are associated to it, methods to download (14) in order to download from a distance said downloadable files (16) in such a manner that one can obtain a common interface for the different user (1) activities: in such a manner that one can substitute a <<Folder, application file>>approach to one of <<User (1) environment (77a) of user (1).
